(19) United States
(12) Patent Application Publication
(10) Pub. No.: US 2014/0182756 A1
(43) Pub. Date: Jul. 3, 2014

(54) PROTECTIVE BIKE COVER

(71) Applicant: WINFRED F. NICHOLSON, ASHBURN, VA (US)

(72) Inventor: WINFRED F. NICHOLSON, ASHBURN, VA (US)

(21) Appl. No.: 14/145,095

(22) Filed: Dec. 31, 2013

Related U.S. Application Data
(60) Provisional application No. 61/748,317, filed on Jan. 2, 2013.

(51) Int. Cl. B62J 19/00

(52) U.S. Cl. CPC B62J 19/00
USPC 150/166

(57) ABSTRACT

The protective bike cover is a cover that provides protection from the elements during transport or storage of a bicycle. The cover is of one-piece design and is fabricated from a supple, highly stretchable waterproof or water-resistant material that is provided with a nylon tricot backing to minimize flapping. The cover includes openings therein for receiving such tie-down devices as locks, bungee cords or the like for attaching and securing the cover to a vehicle or storage rack.

### CROSS-REFERENCE TO RELATED APPLICATION

This application claims the benefit of U.S. Provisional Patent Application Ser. No. 61/748,317, filed Jan. 2, 2013.

### BACKGROUND OF THE INVENTION

1. Field of the Invention

The present invention generally relates to protective coverings, and particularly to a covering that provides a form-fitting protective cover for a bicycle.

2. Description of the Related Art

Bicycling has long been a popular recreational endeavor enjoyed by an avid band of enthusiasts. Bicycle races, mountain trail rides, charity rides, and triathlons are some of the events that are frequently participated in by cyclists. In many instances, it is required to transport the bicycle to the site of the cycling event. This requirement often involves mounting and securing the bicycle to the outside of an automobile. Various carrier racks (trunk, top, rear, etc.) are available to achieve this mounting and securing. Unfortunately, the bicycle and component parts may be subjected to damage by dust, debris and weather conditions when transported on the outside of an automobile or other vehicle. This scenario requires a cover to protect the bicycle during transportation. To be effective, the cover should encase the bicycle and provide a waterproof environment for the bicycle. To prevent flapping in the wind and creation of wind-caused destabilizing effects on the automobile, the cover should be of an aerodynamic design and fit snugly on the bicycle. Adequate means should be provided to secure the cover to the rack, and the cover should be adaptable to a variety of bicycle shapes and sizes. There are many protective covers disclosed in the related art for protecting bicycles during transport or storage. However, the related art covers fail to adequately address the issues cited above in an efficient manner. Thus, a protective bike cover solving the aforementioned problems is desired.

### SUMMARY OF THE INVENTION

The protective bike cover of the present invention is a cover that provides protection from the elements during transport or storage of a bicycle. The cover is of one-piece design and is fabricated from a supple, highly stretchable waterproof or water-resistant material that is provided with a nylon tricot backing to minimize flapping. The cover is adapted to encapsulate the entire bicycle including the pedals and derailleur. The cover includes openings therein for receiving such tie-down devices as locks, bungee cords or the like for attaching and securing the cover to a vehicle or storage rack. The cover may be fabricated in different colors, and the panels provide a surface for logos or advertisements.

Accordingly, the invention presents a protective cover for a bicycle that is easy to install and is adaptable to all conventional vehicle and storage racks. The cover is adapted to fit almost any bicycle size. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a protective bike cover according to the present invention, showing the cover partially installed on the bike.

FIG. 2 is an environmental front view of a bike fully covered by a protective bike cover according to the present invention and shown installed on a rear vehicle rack.

FIG. 2A is partial perspective view of the cover of FIG. 2, showing the zipper arrangement.

FIG. 3 is a front view of a bike fully covered by a protective bike cover according to the present invention, shown installed on a top-mounted auto rack.

FIG. 3A is a partial perspective view of the cover of FIG. 3, showing the lockdown securing arrangement for the bike.

FIG. 4 is a front view of a bike fully covered by a protective bike cover according to the present invention, shown installed on a fork mount rack.

FIG. 4A is a partial perspective view of the cover of FIG. 4, showing the fork cover arrangement.

Similar reference characters denote corresponding features consistently throughout the attached drawings.

### DETAILED DESCRIPTION OF THE PREFERRED EMBODIMENTS

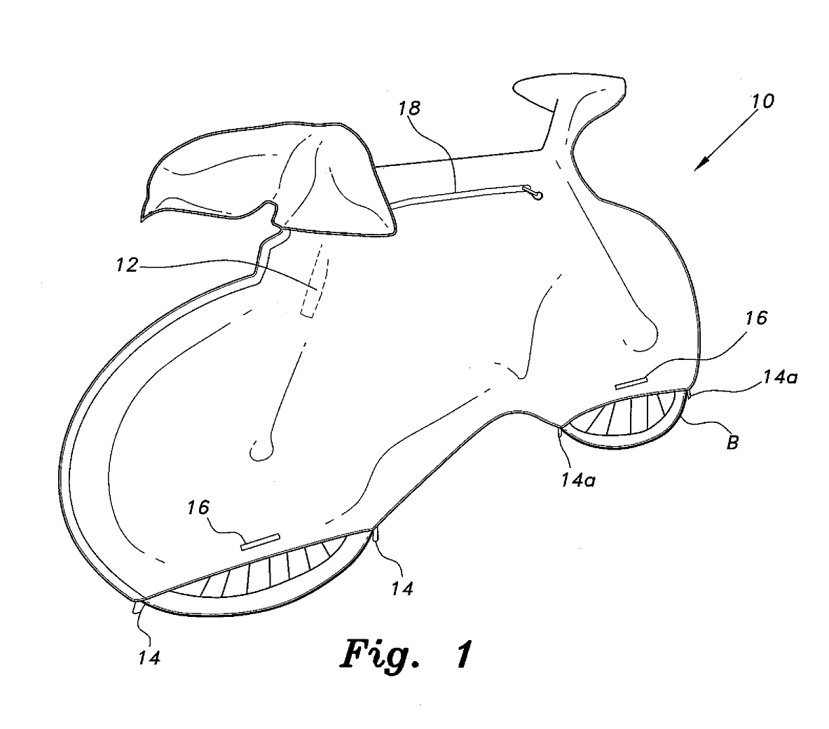

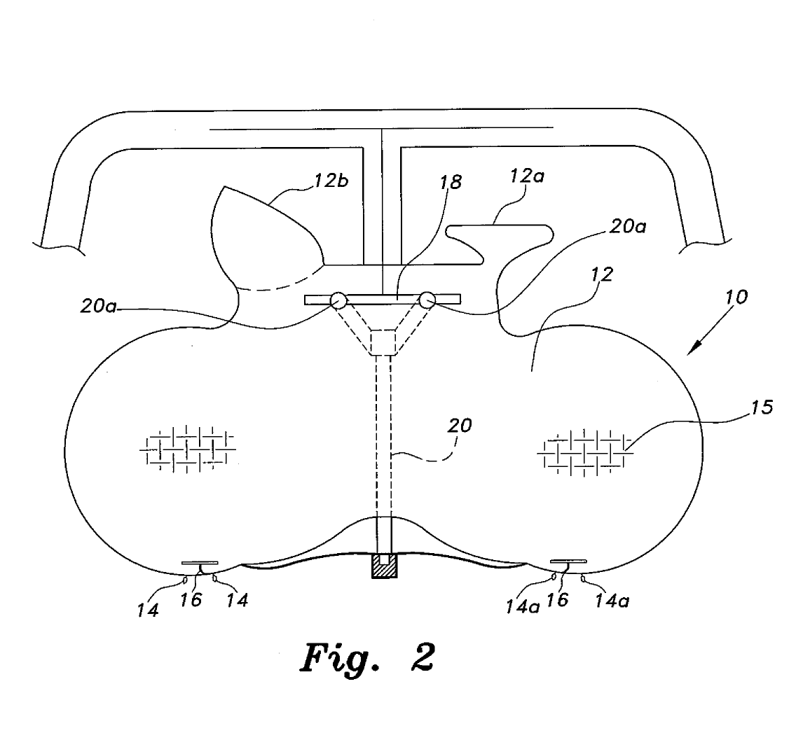

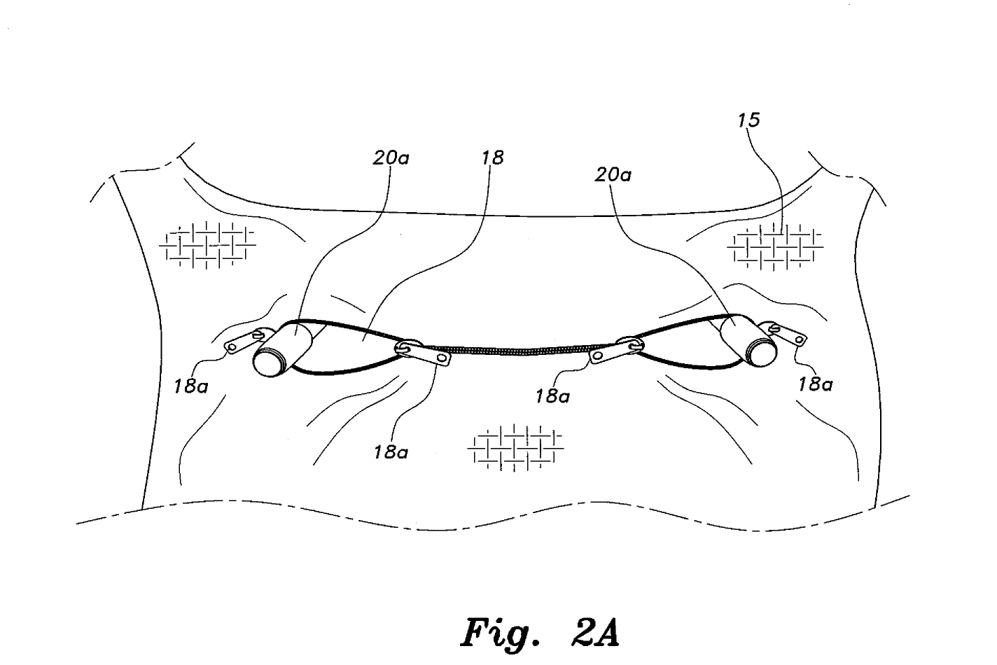

Referring to FIGS. 1 and 2, the protective bike cover is fabricated from a one-piece, breathable, highly stretchable, waterproof fabric forming an envelope having a front panel 12 and an identically formed rear panel. A nylon tricot backing 15 is provided as an inner layer of the cover. The cover is open at the bottom thereof to allow installation on the bicycle B. A plurality of releasable zippers 14, 14a is employed to open and close the bottom of the cover 10. FIG. 1 shows the cover 10 partially installed on a bicycle B, and the cover 10 is shown completely installed in FIG. 2. Identical elongate openings 16 are formed through the front and rear panels 12 adjacent the bottom thereof. Identical zippered elongate openings 18 are provided through the front and rear panels 12 in an area adjacent the top of the cover 10.

As best seen in FIGS. 2 and 2A, the bicycle is mounted to a rear vehicle rack 20. Zippered openings 18 are adapted to receive the mounting bars 20a of the rack therethrough. Zippers 18a function to close the openings 18 to stabilize the cover 10 and provide for a tight fit to prevent the cover 10 from flapping.

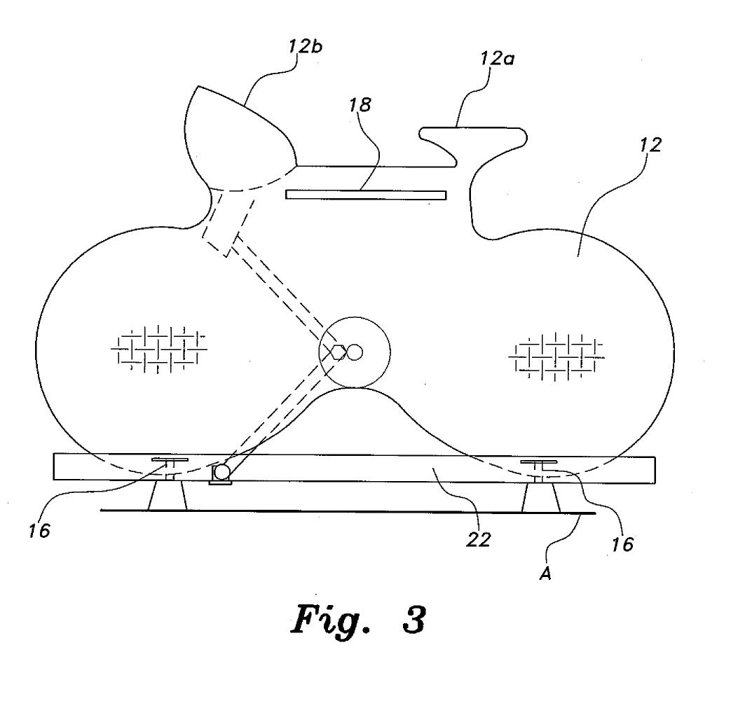

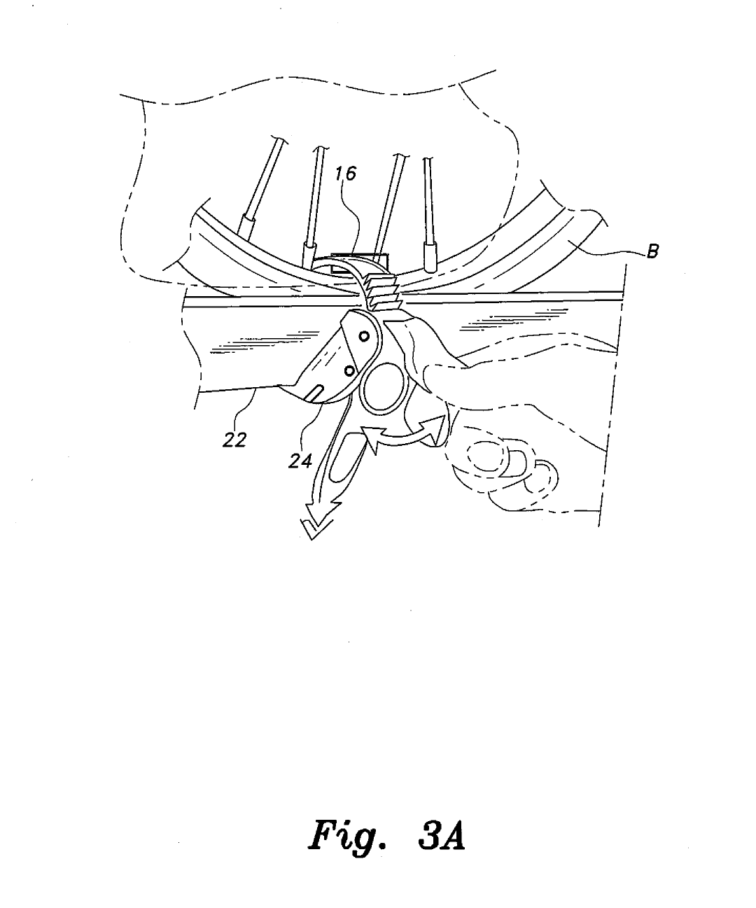

FIGS. 3 and 3A show the bicycle mounted to a roof rack 22 of an automotive vehicle A. The lower openings 16 are designed to receive a locking mechanism 24 to secure the bicycle B to the roof rack 22.

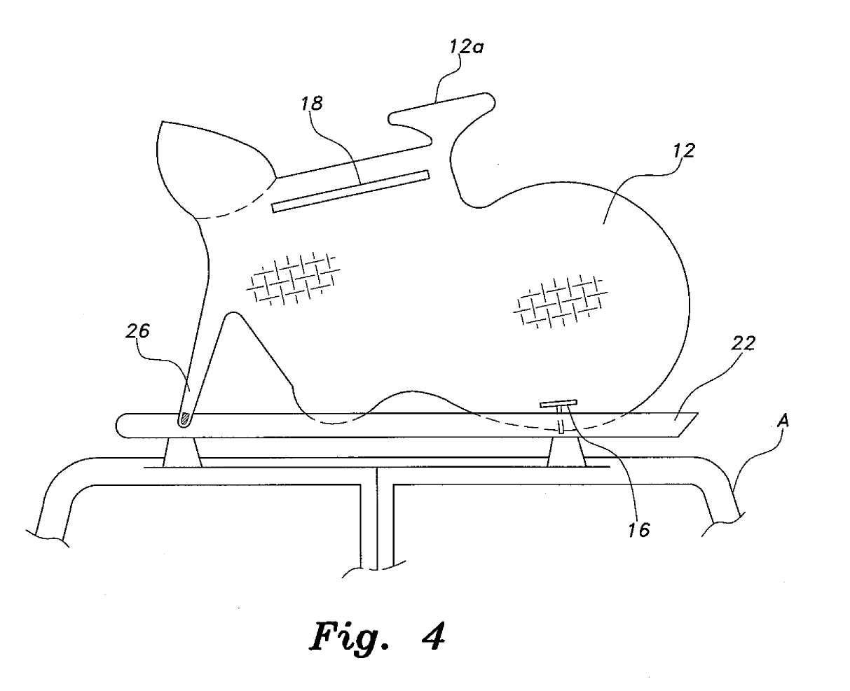

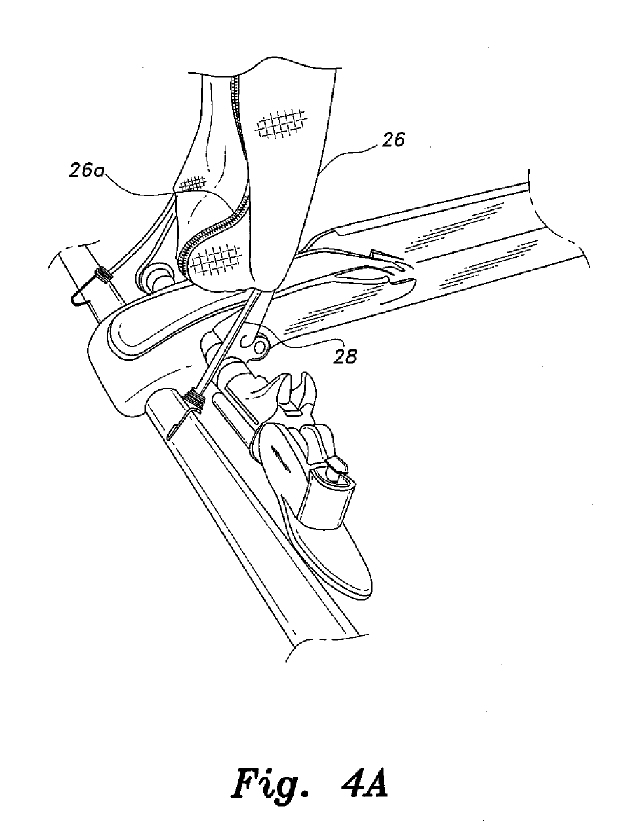

In some instances, as shown in FIGS. 4 and 4A, it is desired to remove the front wheel of the bicycle B, whereby the fork of the bicycle B can be mounted to the roof rack 22. This mounting technique enhances the stability of the bicycle B in high-wind conditions. The cover 10 is provided with a fork covering portion 26 having a zippered opening 26a. Additional openings are formed in the fork cover 26, whereby bungee cords 28 or the like may be employed to secure the bicycle to the roof rack.

In use, zippers 14, 14a are opened and released where necessary and the cover 10 is positioned on the bicycle B, as shown in FIG. 1. The cover 10 is carefully stretched over the seat and handlebars, as shown at 12a and 12b. Further adjustment is required as the cover 10 is stretched over other components, such as the pedals and derailleur. When the bicycle is completely encased, the zippers are closed. Bungee cords or the like may be employed to secure the zippers, if desired.

It is to be understood that the present invention is not limited to the embodiments described above, but encompasses any and all embodiments within the scope of the following claims.

I claim:

1. A protective bicycle cover, comprising:
a one-piece cover member having a front panel and a rear panel joined together to form an envelope having a closed top and an open bottom to encapsulate the bicycle therein;
first closure members positioned at the open bottom for optionally closing the open bottom;
first elongate openings formed through the front panel and the rear panel adjacent the closed top; and
second closure members positioned at the openings adjacent the top for optionally closing the first elongate openings.

2. The protective bicycle cover according to claim 1, wherein said one-piece cover member is fabricated from a supple, stretchable, water-resistant material.

3. The protective bicycle cover according to claim 1, further including second elongate openings formed through the front panel and rear panel adjacent the open bottom, the second elongate openings being adapted to receive a securing device.

4. The protective bicycle cover according to claim 1, wherein said first and said second closure members are zippers.

5. The protective bicycle cover according to claim 1, wherein said cover member has an inner layer fabricated from nylon tricot material.

6. The protective bicycle cover according to claim 1, wherein said cover member has a fork-covering portion adapted to encapsulate a fork of the bicycle.

7. The protective bicycle cover according to claim 5, wherein the fork-covering portion has a plurality of openings therein, the plurality of openings including an elongate opening having a zipper for optionally closing the elongate opening in the fork-covering portion.

8. A protective bicycle cover, comprising:
a one-piece cover member having a front panel and a rear panel joined together to form an envelope having a closed top and an open bottom, the cover member being fabricated from a supple, stretchable, water-resistant material designed to encapsulate the bicycle therein;
first closure members positioned at the open bottom for optionally closing the open bottom;
first elongate openings formed through the front panel and the rear panel adjacent the closed top;
second closure members positioned at the first elongate openings adjacent the top for optionally closing the elongate openings; and
second elongate openings formed through the front panel and rear panel adjacent the open bottom, the second elongate openings being adapted to receive securing devices therethrough.

9. The protective bicycle cover according to claim 8, wherein said first and said second closure members are releasable zippers.

10. The protective bicycle cover according to claim 8, wherein said cover member has an inner layer fabricated from nylon tricot material.

11. The protective bicycle cover according to claim 8, wherein said cover member has a fork-covering portion adapted to encapsulate a fork of the bicycle.

12. The protective bicycle cover according to claim 11, wherein the fork-covering portion has a plurality of openings therein, the plurality of openings including an elongate opening having a zipper for optionally closing the elongate opening in the fork-covering portion.

13. A protective bicycle cover, comprising:
a one-piece cover member having a front panel and a rear panel joined together to form an envelope having a closed top and an open bottom, the cover member being fabricated from a supple, stretchable, water-resistant material designed to encapsulate the bicycle therein;
an inner layer provided for the one-piece cover member, the inner layer being fabricated from nylon tricot material;
releasable zippers positioned at the open bottom for optionally closing the open bottom;
first elongate openings formed through the front panel and the rear panel adjacent the closed top;
zipper members positioned at the first elongate openings adjacent the top for optionally closing the elongate openings; and
second elongate openings formed through the front panel and rear panel adjacent the open bottom, the second elongate openings being adapted to receive securing devices therethrough.

14. The protective bicycle cover according to claim 13, wherein said cover member has a fork-covering portion adapted to encapsulate a fork of the bicycle.

15. The protective bicycle cover according to claim 14, wherein the fork-covering portion has a plurality of openings therein, the plurality of openings including an elongate opening having a zipper for optionally closing the elongate opening in the fork-covering portion.
